(19) United States
(12) Patent Application Publication
(10) Pub. No.: US 2016/0350332 A1
(43) Pub. Date: Dec. 1, 2016

(54) INDIVIDUALIZED ON-DEMAND IMAGE INFORMATION ACQUISITION

(71) Applicant: International Business Machines Corporation, Armonk, NY (US)

(72) Inventors: Hernan A. Cunico, Holly Springs, NC (US); Jonathan D. Dunne, Dungarvan (IE); Jeremiah M. O'Connor, Roscommon Town (IE); Asima Silva, Holden, MA (US)

(21) Appl. No.: 14/725,140

(22) Filed: May 29, 2015

(51) Int. Cl. G06F 17/30; G06K 9/20; G06K 9/78; G06F 3/0484; G06F 3/01

(52) U.S. Cl. CPC G06F 17/30256; G06F 17/30867; G06F 3/04842; G06F 3/013; G06F 17/30268; G06K 9/78; G06K 9/2054

(57) ABSTRACT

A user input is detected at a location within a content rendering user interface within which an image is rendered on a display screen. An object is identified, in real time using image recognition technology, within a portion of the rendered image at the location within the content rendering user interface. Individual user information retrieval preferences that identify information content of interest to a user are retrieved. Information about the identified object located within the portion of the rendered image that matches the retrieved individual user information retrieval preferences of the user is retrieved. The retrieved information about the identified object that matches the retrieved individual user information retrieval preferences of the user is outputted to the user.

### BACKGROUND

The present invention relates to real-time information acquisition. More particularly, the present invention relates to individualized on-demand image information acquisition.

Televisions allow users to watch media content, such as movies, music videos, and television shows. Internet-capable devices allow the users to access and watch media content obtained via the Internet.

### SUMMARY

A method includes detecting a user input at a location within a content rendering user interface within which an image is rendered on a display screen; identifying, in real time using image recognition technology, an object within a portion of the rendered image at the location within the content rendering user interface; retrieving individual user information retrieval preferences that identify information content of interest to a user; retrieving information about the identified object located within the portion of the rendered image that matches the retrieved individual user information retrieval preferences of the user; and outputting to the user the retrieved information about the identified object that matches the retrieved individual user information retrieval preferences of the user.

A system that performs the method and a computer program product that causes a computer to perform the method are also described.

### BRIEF DESCRIPTION OF THE DRAWINGS

FIG. 1 is a block diagram of an example of an implementation of a system for individualized on-demand image information acquisition according to an embodiment of the present subject matter;

FIG. 2 is a block diagram of an example of an implementation of a core processing module capable of performing individualized on-demand image information acquisition according to an embodiment of the present subject matter;

FIG. 3 is a flow chart of an example of an implementation of a process for individualized on-demand image information acquisition according to an embodiment of the present subject matter; and

FIG. 4 is a flow chart of an example of an implementation of a process for individualized on-demand image information acquisition that performs individualized information searches and additional information retrieval according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides individualized on-demand image information acquisition. The present technology solves a recognized information acquisition problem by providing technology that includes a new form of computing platform that responds in real time to recognize image content that a user has specified, and that utilizes a user's individualized interest profile to retrieve additional information related to the recognized image content that is of interest to the user. By retrieving specific information that is known to be of interest to the user in real time and on demand, network bandwidth requirements may be reduced by avoiding delivery of information that may not be of interest or relevant to the particular user. Additionally, memory requirements and processor occupancy in user equipment may be reduced because non-relevant information is not received or processed. Additionally, because the technology described herein operates in real time and on demand to recognize image content that is specified by the user, while content and/or media stream modification may be optionally performed, no content or media stream modification is required by use of the technology as described herein, which further reduces bandwidth, processor occupancy at streaming servers, and memory requirements because no metadata or selectable segments in video content are needed (not stored, transmitted, or processed).

The technology described herein operates by detecting a user input at a location within a content rendering user interface within which an image is rendered on a display screen. An object located within a portion of the rendered image at the location within the content rendering user interface is identified in real time using image recognition technology. Individual user information retrieval preferences that identify information content of interest to the specific user are retrieved. Information about the object identified within the portion of the image that matches the retrieved individual user information retrieval preferences of the user is retrieved. The identified information about the object that matches the retrieved individual information retrieval preferences of the user is output to the user. As such, the technology described herein provides an individualized and on-demand technology that allows a user to specify the user's own individualized information retrieval preferences for objects of interest to the particular user within image content.

The following description provides an example usage scenario of the present technology. Where a user is viewing video content, such as a television program about fashion, the user may see an item that is of interest to the user (e.g., handbag, shoes, necklace, etc.). The user may initiate an inquiry about the item by navigating using a pointing device within a content rendering user interface of the television to a location within the image where the particular item of interest is rendered. The user may perform an input action (e.g., enter, click, etc.) and the content rendering user interface may determine a location/coordinates of the pointing device within the content rendering user interface. In response to detection of the input action, the image content is captured (e.g., still image or a frame of video content) and an image recognition module performs image recognition within the image content at the specified location/coordinates. The item may then be identified based upon the image recognition and a user-specific search for information about the item may be performed using an individualized image content interest profile of the user to identify information that is of interest to this particular individual. The user may be provided with identified user-specific information about the item that is of interested to this particular user.

The terms “individualized image content interest profile,” “individualized user information profile,” and “user profile” (and similar terms for brevity) are used interchangeably herein. These terms collectively refer to individual user information retrieval preferences that a user has configured to identify specific types of information, of interest to the specific user, that are to be retrieved responsive to the user selecting an area within a user interface that renders an image/object. The individual user information retrieval preferences may be configured within a user-specific individualized user information profile.

To further the example of the individualized user-specific information that may be retrieved and provided to the individual user, where the user is a fashion design student interested in a career in fashion design, the user may configure an individualized image content interest profile that specifies that the user is interested in learning fashion designer information (e.g., where the designer of the item studied fashion design, the designer's level of education in fashion design, the designer's biographical information and job history including how long the designer has worked for the particular manufacturer of the item, the designer's current job title, etc.). Alternatively, where the user is a working professional in a field different from fashion design and is interested in becoming more conversant in fashion design nomenclature or purchasing the latest fashion trending products, the user may configure an individualized content interest profile that specifies that they are interested in learning manufacturer identifications, manufacturer information such as name recognition within the marketplace, product type identifiers (e.g., handbags versus purses, shoes versus sandals, etc.), brand names or trade names of the pictured items, a retail value/cost, a minimum advertised price (MAP), and that specifies that they would like to be provided with links to one or more vendors that sell the item and/or opportunities to purchase items (e.g., coupons, discount codes, etc.).

As such, the particular users may individually tailor the information retrieved responsive to their respective interests. Further, the types of information retrieved may be different for each individual user, even where the users specify the same object within an image to be of interest. The present technology assists users with learning what they individually want to learn about items within image content on demand and in real time responsive to the user's inquiry.

Further, where multiple users are watching a media stream together, the preferences of each user within their respective user interest profile may be combined. For example, the respective criteria in the respective user interest profiles may be combined as a union of the respective individual interests, may be combined as an intersection of the respective individual interests, or may be combined otherwise as appropriate for a given implementation to retrieve information of a granularity that is of interest to the users as a group.

Regarding presentation of the individualized information to the user, the present technology may utilize a local content overlay technique (e.g., a pop-up dialog, pop-up cloud, etc.) within a user interface that renders the image to provide the retrieved individualized information over a portion of the rendered image, such as an area of the image different from the object for which the information was retrieved. The content overlay itself (as opposed to the image over which the overlay is rendered) or individual information elements within the content overlay may be made selectable within the user interface that is rendering the image to allow the user to further investigate the information that has been provided (e.g., using hypertext link technology or other technology as appropriate). Alternatively, the display size of the image may be reduced to provide room for an information pane beside, above, or below the image, and the retrieved individualized information may be provided within the information pane. Again, the information pane or the individual information elements within the information pane may be made selectable within the user interface that is rendering the image and the information pane to allow the user to further investigate the information that has been provided. As another alternative, a multiscreen device setup may be utilized, where a user may watch content of a video stream on a main screen, and the retrieved individualized information may be delivered to and displayed on a secondary screen (e.g., a second monitor, a tablet, a smartphone, a second television display, etc.). As such, many alternatives are possible for delivery of the retrieved individualized information to the user(s).

It should also be noted that the present technology may additionally/alternatively utilize content/media stream modification from a media stream distribution device to place the requested information within the respective image content or media stream. However, it should also be noted that such additional processing may be considered optional and the present technology may operate without performing any modification to the image content or the media stream. As such, existing media distribution infrastructure equipment may be integrated for use with the present technology without the costs of development and deployment of new media infrastructure distribution equipment.

Additionally, where product information, such as promotions, vendors, and other marketplace information, is designated by the user to be provided, the individualized information may be derived according to user preferences from one or multiple vendors. As such, the individualized information need not have one specific vendor. Further, advertising may be provided via a tiered list of vendors that are ranked according to an amount of revenue they pay for having their e-shop available as first choice where users specifically configure their individual interest profiles to authorize advertisements.

It should be noted that conception of the present subject matter resulted from recognition of certain limitations associated with information acquisition in real time. For example, it was observed that a user of an Internet-capable device may browse a website and receive targeted paid advertising. However, it was also observed that two different users may be watching the same video, yet the two user's interest may be different and that the paid advertisements provided by conventional technology are not based upon content that may be of interest to the user. It was further observed that these paid advertisements consume resources, such as bandwidth, processor occupancy on the user's equipment, and memory, yet do not with any certainty provide any information that is known to be of interest to the user. As such, it was determined that these conventional approaches to information distribution are inefficient, lack accuracy, and unnecessarily consume valuable real-time resources within user media equipment. It was further determined it would be desirable to allow a user of media equipment to be able to specify an area of a display screen that is rendering an image (e.g., clicking at a location of a region of a still image or a video), and for the media equipment to determine what object is represented within the image content at the specified location of the display screen. It was determined that it would further be desirable for the user's media equipment to obtain information that is known to be relevant to the user and related to the identified object by use of a user profile configured with user information content preferences. However, it was determined that there is no previous technology available by which a user may specify a portion of raw/unmodified image content in real time and be provided with information that is known to be relevant and of interest to the user. The present subject matter improves real-time individualized information acquisition by providing for user-controlled identification of objects within images for which information is to be obtained, as described above and in more detail below. As such, improved individualized on-demand image information acquisition may be obtained through use of the present technology.

The individualized on-demand image information acquisition described herein may be performed in real time to allow prompt acquisition of information that is specific to interests of a user. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

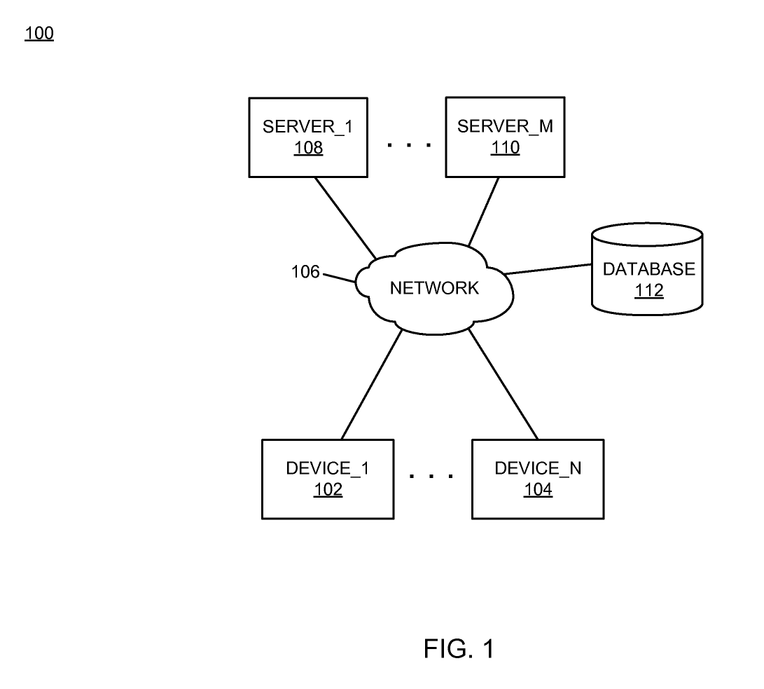

FIG. 1 is a block diagram of an example of an implementation of a system 100 for individualized on-demand image information acquisition. A computing device_1 102 through a computing device_N 104 communicate via a network 106 with several other devices. The other devices include a server_1 108 through a server_M 110. The respective devices may also interact with and store/retrieve information, such as media and image content, and individualized image content interest profiles, using a database 112.

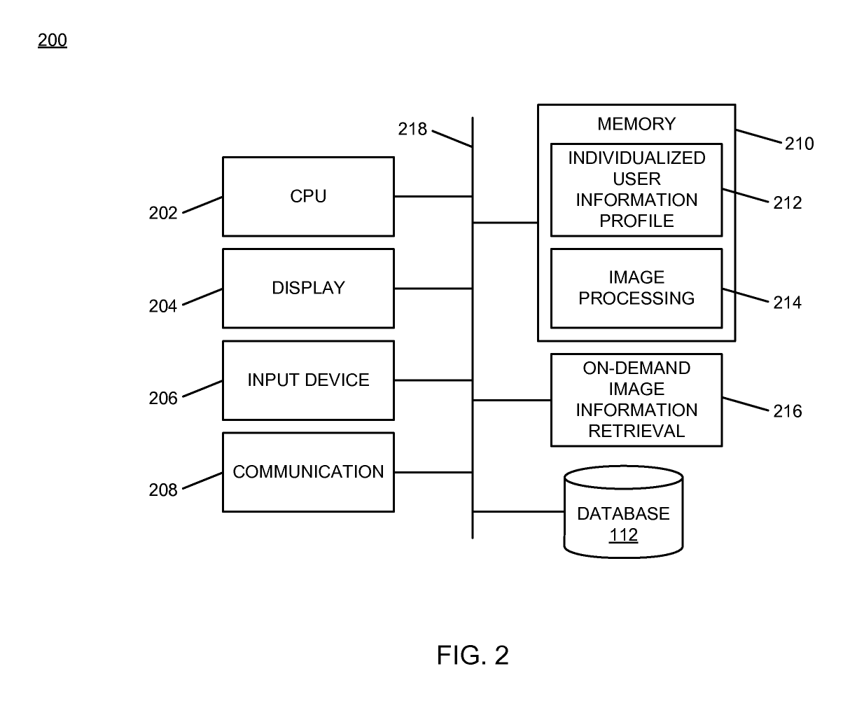

As will be described in more detail below in association with FIG. 2 through FIG. 4, the computing device_1 102 through the computing device_N 104 and/or the server_1 108 through the server_M 110 may each provide automated individualized on-demand image information acquisition. As such, the present technology may be implemented at a user computing device or server device level, or by a combination of such devices as appropriate for a given implementation. The automated individualized on-demand image information acquisition is based upon user-specification of individualized content interest profiles that designate what types of information to retrieve responsive to specification of a portion of an image the user is viewing. A variety of possibilities exist for implementation of the present subject matter, and all such possibilities are considered within the scope of the present subject matter.

The network 106 may include any form of interconnection suitable for the intended purpose, including a private or public network such as an intranet or the Internet, respectively, direct inter-module interconnection, dial-up, wireless, or any other interconnection mechanism capable of interconnecting the respective devices.

The server_1 108 through the server_M 110 may include any device capable of providing data for consumption by a device, such as the computing device_1 102 through the computing device_N 104, via a network, such as the network 106. As such, the server_1 108 through the server_M 110 may each include a web server, an application server, a content/media distribution device, or other data server device.

The database 112 may include a relational database, an object database, or any other storage type of device. As such, the database 112 may be implemented as appropriate for a given implementation.

FIG. 2 is a block diagram of an example of an implementation of a core processing module 200 capable of performing individualized on-demand image information acquisition. The core processing module 200 may be associated with either the computing device_1 102 through the computing device_N 104 or with the server_1 108 through the server_M 110, as appropriate for a given implementation. As such, the core processing module 200 is described generally herein, though it is understood that many variations on implementation of the components within the core processing module 200 are possible and all such variations are within the scope of the present subject matter.

Further, the core processing module 200 may provide different and complementary processing of individualized information retrieval in association with each implementation. As such, for any of the examples below, it is understood that any aspect of functionality described with respect to any one device that is described in conjunction with another device (e.g., sends/sending, etc.) is to be understood to concurrently describe the functionality of the other respective device (e.g., receives/receiving, etc.).

A central processing unit (CPU) 202 (“processor”) provides hardware that performs computer instruction execution, computation, and other capabilities within the core processing module 200. A display 204 provides visual information to a user of the core processing module 200 and an input device 206 provides input capabilities for the user. The input device 206 may also provide an input interface for a camera associated with a content rendering device to allow camera-based user gaze detection to assist with identification of a rendered object about which the user is interested in obtaining information.

The display 204 may include any display device, such as a cathode ray tube (CRT), liquid crystal display (LCD), light emitting diode (LED), electronic ink displays, projection, touchscreen, or other display element or panel. The input device 206 may include a computer keyboard, a keypad, a mouse, a pen, a joystick, touchscreen, voice command processing unit, or any other type of input device by which the user may interact with and respond to information on the display 204.

A communication module 208 provides hardware, protocol stack processing, and interconnection capabilities that allow the core processing module 200 to communicate with other modules within the system 100. The communication module 208 may include any electrical, protocol, and protocol conversion capabilities useable to provide interconnection capabilities, as appropriate for a given implementation. As such, the communication module 208 represents a communication device capable of carrying out communications with other devices.

A memory 210 includes an individualized user information profile storage area 212 that stores one or more individualized image content interest profiles in association with the core processing module 200. As will be described in more detail below, user profiles stored within the individualized user information profile storage area 212 are used to retrieve information of specific and configured interest to the particular user in response to receipt of a request from the user to retrieve individualized information related to a rendered object within an image.

The memory 210 also includes an image processing area 214. The image processing area 214 may be utilized to store and execute a content rendering user interface. The image processing area 214 may also be utilized to store and perform image recognition on captured frames/images to identify objects within an image responsive to a user selection of an area of a content rendering user interface, and to compare the identified objects with user-specific information preferences encoded within an individualized image content interest profile of the user.

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

An on-demand image information retrieval module 216 is also illustrated. The on-demand image information retrieval module 216 provides individualized information retrieval associated with objects recognized within image content for the core processing module 200, as described above and in more detail below. The on-demand image information retrieval module 216 implements the automated individualized on-demand image information acquisition of the core processing module 200. The on-demand image information retrieval module 216 may implement image recognition technology to identify a rendered object the user is interested in obtaining information about. The on-demand image information retrieval module 216 may additionally/alternatively utilize the input interface of the input device 206 to process camera imagery of the user to allow camera-based user gaze detection to assist with identification of a rendered object about which the user is interested in obtaining information.

It should also be noted that the on-demand image information retrieval module 216 may form a portion of other circuitry described without departure from the scope of the present subject matter. Further, the on-demand image information retrieval module 216 may alternatively be implemented as an application stored within the memory 210. In such an implementation, the on-demand image information retrieval module 216 may include instructions executed by the CPU 202 for performing the functionality described herein. The CPU 202 may execute these instructions to provide the processing capabilities described above and in more detail below for the core processing module 200. The on-demand image information retrieval module 216 may form a portion of an interrupt service routine (ISR), a portion of an operating system, a portion of a browser application, or a portion of a separate application without departure from the scope of the present subject matter.

The database 112 is again shown within FIG. 2 associated with the core processing module 200. As such, the database 112 may be operatively coupled to the core processing module 200 without use of network connectivity, as appropriate for a given implementation.

The CPU 202, the display 204, the input device 206, the communication module 208, the memory 210, the on-demand image information retrieval module 216, and the database 112 are interconnected via an interconnection 218. The interconnection 218 may include a system bus, a network, or any other interconnection capable of providing the respective components with suitable interconnection for the respective purpose.

Though the different modules illustrated within FIG. 2 are illustrated as component-level modules for ease of illustration and description purposes, it should be noted that these modules may include any hardware, programmed processor(s), and memory used to carry out the functions of the respective modules as described above and in more detail below.

For example, the modules may include additional controller circuitry in the form of application specific integrated circuits (ASICs), processors, antennas, and/or discrete integrated circuits and components for performing communication and electrical control activities associated with the respective modules. Additionally, the modules may include interrupt-level, stack-level, and application-level modules as appropriate. Furthermore, the modules may include any memory components used for storage, execution, and data processing for performing processing activities associated with the respective modules. The modules may also form a portion of other circuitry described or may be combined without departure from the scope of the present subject matter.

Additionally, while the core processing module 200 is illustrated with and has certain components described, other modules and components may be associated with the core processing module 200 without departure from the scope of the present subject matter. Additionally, it should be noted that, while the core processing module 200 is described as a single device for ease of illustration purposes, the components within the core processing module 200 may be co-located or distributed and interconnected via a network without departure from the scope of the present subject matter. Many other possible arrangements for components of the core processing module 200 are possible and all are considered within the scope of the present subject matter. It should also be understood that, though the database 112 is illustrated as a separate component for purposes of example, the information stored within the database 112 may also/alternatively be stored within the memory 210 without departure from the scope of the present subject matter. Accordingly, the core processing module 200 may take many forms and may be associated with many platforms.

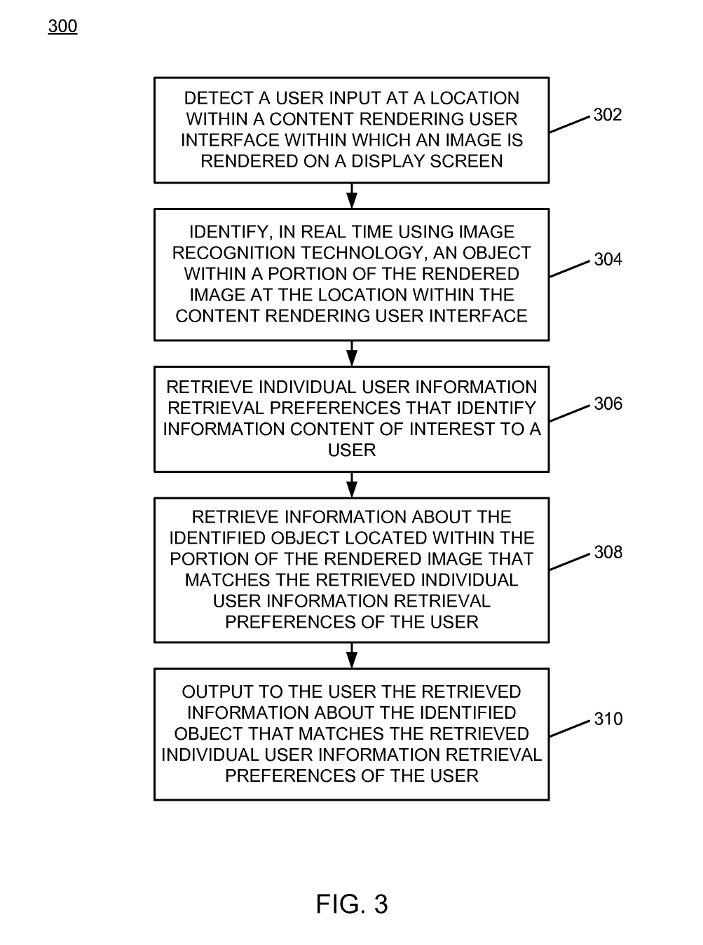

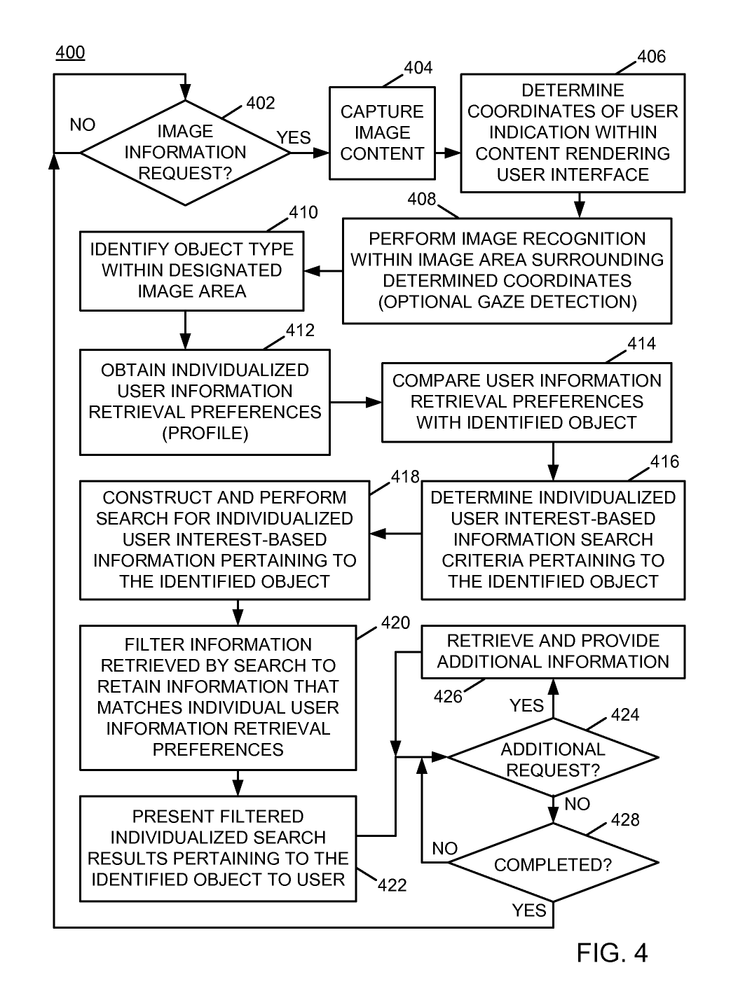

FIG. 3 through FIG. 4 described below represent example processes that may be executed by devices, such as the core processing module 200, to perform the automated individualized on-demand image information acquisition associated with the present subject matter. Many other variations on the example processes are possible and all are considered within the scope of the present subject matter. The example processes may be performed by modules, such as the on-demand image information retrieval module 216 and/or executed by the CPU 202, associated with such devices. It should be noted that time out procedures and other error control procedures are not illustrated within the example processes described below for ease of illustration purposes. However, it is understood that all such procedures are considered to be within the scope of the present subject matter. Further, the described processes may be combined, sequences of the processing described may be changed, and additional processing may be added or removed without departure from the scope of the present subject matter.

FIG. 3 is a flow chart of an example of an implementation of a process 300 for individualized on-demand image information acquisition. The process 300 represents a computer-implemented method of performing the dynamic individualized information retrieval for objects of interest to a user within rendered image content as described herein. At block 302, the process 300 detects a user input at a location within a content rendering user interface within which an image is rendered on a display screen. At block 304, the process 300 identifies, in real time using image recognition technology, an object within a portion of the rendered image at the location within the content rendering user interface. At block 306, the process 300 retrieves individual user information retrieval preferences that identify information content of interest to a user. At block 308, the process 300 retrieves information about the identified object located within the portion of the rendered image that matches the retrieved individual user information retrieval preferences of the user. At block 310, the process 300 outputs to the user the retrieved information about the identified object that matches the retrieved individual user information retrieval preferences of the user.

FIG. 4 is a flow chart of an example of an implementation of a process 400 for individualized on-demand image information acquisition that performs individualized information searches and additional information retrieval. The process 400 represents a computer-implemented method of performing dynamic individualized information retrieval for objects of interest to a user within rendered image content as described herein. At decision point 402, the process 400 makes a determination as to whether an image information request has been detected responsive to input(s) by the user. As such, the process 400 detects an individualized user information request. For example, the user may perform a select operation at a location within a content rendering user interface within which an image is rendered on a display screen, such as by use of a mouse or other pointing device. It should be noted that the content rendering user interface may be implemented with a coordinate and/or grid system so that the location of the selection may be mapped onto image content of the image that is rendered within the content rendering user interface.

In response to determining at decision point 402 that an image information request has been detected responsive to input(s) by the user, the process 400 captures image content at block 404. It should be noted that the image may be a still image or a video stream that includes multiple images. As such, by capturing the image at the time of the detected user selection, the process 400 may preserve image content for further analysis, such as where a video stream may readily change the image content over time. Further, for a video stream encoded pursuant to an applicable video encoding standard, the captured image may include capturing an intra-coded video frame (I-frame) that includes all portions of the image content, rather than capturing predicted frames (P-frames) or bi-directional predicted frames (B-frames) that include content changes relative to other frames of image content.

At block 406, the process 400 determines coordinates of the user indication within the content rendering user interface. At block 408, the process 400 performs image recognition within an image area surrounding the determined coordinates, with optional additional user gaze detection to assist in refining the object that the user is focused on. At block 410, the process 400 identifies an object type within the designated image area. As such, the process 400 may identify the object utilizing a combination of image recognition and camera-based user gaze detection.

At block 412, the process 400 obtains individualized user information retrieval preferences, such as an individualized image content interest profile configured by the specific user with user information retrieval preferences of the specific user. At block 414, the process 400 compares the user information retrieval preferences with the identified object and/or object type. At block 416, the process 400 determines individualized user interest-based information search criteria pertaining to the identified object. At block 418, the process 400 constructs and performs a search for individualized user interest-based information pertaining to the identified object using the individualized user interest-based information search criteria. At block 420, the process 400 filters information retrieved by the information search to retain information that matches the individual user information retrieval preferences. At block 422, the process 400 presents the filtered individualized search results pertaining to the identified object to the user. Many options exist for presenting the filtered individualized search results pertaining to the identified object to the user. For example, the process 400 may output the filtered individualized search results by encoding the results into the video stream (e.g., either locally or at a media content server). The process 400 may alternatively utilize a pop-up overlay and present the filtered results over the rendered image. As another alternative, the process 400 may shrink the image within the content rendering user interface and display the filtered results above, below, or to a side of the rendered image. As another alternative, the process 400 may output the matching information to a display of a separate device (e.g., a mobile phone, tablet, etc.) from a device that provides the content rendering user interface. As such, many possibilities exist for outputting the filtered individualized search results pertaining to the identified object to the user responsive to the processing described within the process 400, and all such possibilities are considered within the scope of the present subject matter.

It should be understood that the variety of information output to the user may include information as specifically designated/configured by the user (e.g., clothes designer information, manufacturer information, consumer item ratings, cost, purchase locations, etc.) as appropriate for the particular user's interests/profile. Any of these items of information may additionally be configured as hypertext links that allow retrieval of additional information and/or facilitate purchase of the items if selected by the user. As such, at decision point 424, the process 400 makes a determination as to whether an additional information request has been detected, such as by selection of an item of information within the filtered individualized search results.

In response to determining that an additional information request has been detected, the process 400 retrieves and provides the requested additional information to the user at block 426. For example, where the identified information about the object that matches the retrieved individual information retrieval preferences of the user includes a hypertext link to additional information about the object, the process 400 may detect a user selection of the hypertext link, and may provide additional information to the user about the object that is available via the hypertext link and a server that hosts the content accessed by the hypertext link. To further the present example, the process 400 may facilitate, via the hypertext link or otherwise as appropriate for a given implementation, a purchase by the user of the object located within the portion of the rendered image at the location within the content rendering user interface. The process 400 may additionally retrieve coupons or other promotions for purchase of the object. It should be noted that many possibilities exist for providing additional information responsive to the processing described within the process 400, and that all such possibilities are considered within the scope of the present subject matter.

In response to providing the requested additional information to the user at block 426, or in response to determining at decision point 424 that an additional information request has not been detected, the process 400 make a determination at decision point 428 as to whether processing is completed. In response to determining that processing is not completed, the process 400 returns to decision point 424 and iterates as described above. Alternatively, in response to determining that processing is completed, the process 400 returns to decision point 402 and iterates as described above.

As such, the process 400 detects user selection actions (e.g., via a mouse or other pointing input device) within a content rendering user interface that renders an image (e.g., still image or video stream). The process 400 identifies an object located within the image near the location of the user selection using image recognition and/or user gaze detection. The process 400 obtains individualized user information retrieval preferences, and retrieves information that is specifically of interest as configured by the user responsive to the user selection of the image. Accordingly, the process 400 provides individualized on-demand image information acquisition.

As described above in association with FIG. 1 through FIG. 4, the example systems and processes provide individualized on-demand image information acquisition. Many other variations and additional activities associated with individualized on-demand image information acquisition are possible and all are considered within the scope of the present subject matter.

Those skilled in the art will recognize, upon consideration of the above teachings, that certain of the above examples are based upon use of a programmed processor, such as the CPU 202. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art based upon the teachings herein without departing from the scope and spirit of the invention. The subject matter was described to explain the principles of the invention and the practical application, and to enable others of ordinary skill in the art to understand the invention for various embodiments with various modifications as are suited to the particular use contemplated.

What is claimed is:

1. A method, comprising:
detecting a user input at a location within a content rendering user interface within which an image is rendered on a display screen;
identifying, in real time using image recognition technology, an object within a portion of the rendered image at the location within the content rendering user interface;
retrieving individual user information retrieval preferences that identify information content of interest to a user;
retrieving information about the identified object located within the portion of the rendered image that matches the retrieved individual user information retrieval preferences of the user; and
outputting to the user the retrieved information about the identified object that matches the retrieved individual user information retrieval preferences of the user.

2. The method of claim 1, where identifying, in real time using image recognition technology, the object within the portion of the rendered image at the location within the content rendering user interface comprises identifying the object utilizing a combination of image recognition and camera-based user gaze detection.

3. The method of claim 1, where retrieving the individual user information retrieval preferences that identify information content of interest to the user comprises obtaining an individualized image content interest profile configured by the user with the individual user information retrieval preferences of the user.

4. The method of claim 1, where retrieving the information about the identified object located within the portion of the rendered image that matches the retrieved individual user information retrieval preferences of the user comprises:
performing an information search for individualized user interest-based information pertaining to the identified object; and
filtering information retrieved by the information search to retain information that matches the individual user information retrieval preferences.

5. The method of claim 1, where outputting to the user the retrieved information about the identified object that matches the retrieved individual user information retrieval preferences of the user comprises:
outputting the matching information to a display of a separate device from a device that provides the content rendering user interface.

6. The method of claim 1, where the retrieved information about the identified object that matches the retrieved individual user information retrieval preferences of the user comprises a hypertext link to additional information about the identified object and further comprising:
detecting a user selection of the hypertext link; and
providing the additional information to the user via the hypertext link.

7. The method of claim 6, further comprising facilitating, via the hypertext link, a purchase by the user of the identified object within the portion of the rendered image at the location within the content rendering user interface.

8. A system, comprising:
an input device; and
a processor programmed to:
detect a user input via the input device at a location within a content rendering user interface within which an image is rendered on a display screen;
identify, in real time using image recognition technology, an object within a portion of the rendered image at the location within the content rendering user interface;
retrieve individual user information retrieval preferences that identify information content of interest to a user;
retrieve information about the identified object located within the portion of the rendered image that matches the retrieved individual user information retrieval preferences of the user; and
output to the user the retrieved information about the identified object that matches the retrieved individual user information retrieval preferences of the user.

9. The system of claim 8, where, in being programmed to identify, in real time using image recognition technology, the object within the portion of the rendered image at the location within the content rendering user interface, the processor is programmed to identify the object utilizing a combination of image recognition and camera-based user gaze detection.

10. The system of claim 8, where, in being programmed to retrieve the individual user information retrieval preferences that identify information content of interest to the user, the processor is programmed to obtain an individualized image content interest profile configured by the user with the individual user information retrieval preferences of the user.

11. The system of claim 8, where, in being programmed to retrieve the information about the identified object located within the portion of the rendered image that matches the retrieved individual user information retrieval preferences of the user, the processor is programmed to:
perform an information search for individualized user interest-based information pertaining to the identified object; and
filter information retrieved by the information search to retain information that matches the individual user information retrieval preferences.

12. The system of claim 8, where, in being programmed to output to the user the retrieved information about the identified object that matches the retrieved individual user information retrieval preferences of the user, the processor is programmed to:
output the matching information to a display of a separate device from a device that provides the content rendering user interface.

13. The system of claim 8, where the retrieved information about the identified object that matches the retrieved individual user information retrieval preferences of the user comprises a hypertext link to additional information about the identified object and the processor is further programmed to:
detect a user selection via the input device of the hypertext link;
provide the additional information to the user via the hypertext link; and
facilitate, via the hypertext link, a purchase by the user of the identified object within the portion of the rendered image at the location within the content rendering user interface

14. A computer program product, comprising:
a computer readable storage medium having computer readable program code embodied therewith, where the computer readable storage medium is not a transitory signal per se and where the computer readable program code when executed on a computer causes the computer to:
detect a user input at a location within a content rendering user interface within which an image is rendered on a display screen;
identify, in real time using image recognition technology, an object within a portion of the rendered image at the location within the content rendering user interface;
retrieve individual user information retrieval preferences that identify information content of interest to a user;
retrieve information about the identified object located within the portion of the rendered image that matches the retrieved individual user information retrieval preferences of the user; and
output to the user the retrieved information about the identified object that matches the retrieved individual user information retrieval preferences of the user.

15. The computer program product of claim 14, where, in causing the computer to identify, in real time using image recognition technology, the object within the portion of the rendered image at the location within the content rendering user interface, the computer readable program code when executed on the computer causes the computer to identify the object utilizing a combination of image recognition and camera-based user gaze detection.

16. The computer program product of claim 14, where, in causing the computer to retrieve the individual user information retrieval preferences that identify information content of interest to the user, the computer readable program code when executed on the computer causes the computer to obtain an individualized image content interest profile configured by the user with the individual user information retrieval preferences of the user.

17. The computer program product of claim 14, where, in causing the computer to retrieve the information about the identified object located within the portion of the rendered image that matches the retrieved individual user information retrieval preferences of the user, the computer readable program code when executed on the computer causes the computer to:
perform an information search for individualized user interest-based information pertaining to the identified object; and
filter information retrieved by the information search to retain information that matches the individual user information retrieval preferences.

18. The computer program product of claim 14, where, in causing the computer to output to the user the retrieved information about the identified object that matches the retrieved individual user information retrieval preferences of the user, the computer readable program code when executed on the computer causes the computer to:
output the matching information to a display of a separate device from a device that provides the content rendering user interface.

19. The computer program product of claim 14, where the retrieved information about the identified object that matches the retrieved individual user information retrieval preferences of the user comprises a hypertext link to additional information about the identified object and the computer readable program code when executed on the computer further causes the computer to:
detect a user selection of the hypertext link; and
provide the additional information to the user via the hypertext link.

20. The computer program product of claim 19, where the computer readable program code when executed on the computer further causes the computer to facilitate, via the hypertext link, a purchase by the user of the identified object within the portion of the rendered image at the location within the content rendering user interface.
